(19) United States
(12) Patent Application Publication
(10) Pub. No.: US 2010/0064865 A1
(43) Pub. Date: Mar. 18, 2010

(54) HAND TOOL HAVING AN ANTISLIP FUNCTION

(76) Inventor: Jack LIN, Taichung City (TW)

Correspondence Address: Dr. BANGER SHIA;Int''l Patent Office of Bang Shia, 102 Lindencrest Ct, Sugar Land, TX, 77479-5201, US

(21) Appl. No.: 12/233,093

(22) Filed: Sep. 18, 2008

(51) Int. Cl. B25G 1/10

(52) U.S. Cl. 81/492; 16/430

(57) ABSTRACT

A hand tool includes a shank having a first end provided with a drive portion and a second end provided with a handle portion, and an antislip structure including an antislip member mounted around the handle portion of the shank. The antislip member of the antislip structure includes a bonding glue bonded onto an outer surface of the handle portion of the shank and a woven wool layer mounted on a surface of the bonding glue. Thus, the woven wool layer of the antislip member has a high friction, so that when the antislip member is mounted on the handle portion of the shank, the handle portion of the shank has a greater antislip feature, thereby facilitating a user holding the handle portion of the shank.

### BACKGROUND OF THE INVENTION

1. Field of the Invention

The present invention relates to a hand tool, and more particularly to a hand tool, such as a socket wrench, an open-ended spanner, a combination wrench, a ratchet wrench and the like.

2. Description of the Related Art

A conventional hand tool, such as a socket wrench, an open-ended spanner, a combination wrench, a ratchet wrench and the like, comprises a shank having a first end provided with a drive portion and a second end provided with a handle portion, and a soft jacket mounted on the handle portion of the shank. Thus, when a user holds the handle portion to drive the drive portion to operate a workpiece, such as a bolt, nut and the like, the soft jacket provides a buffering effect to the user, thereby providing a comfortable sensation to the user when holding the handle portion. However, when oil is deposited on the surface of the soft jacket, the users hand easily slips from the soft jacket when holding the handle portion, thereby causing inconvenience to the user.

### SUMMARY OF THE INVENTION

The present invention is to mitigate and/or obviate the disadvantage of the conventional hand tool.

The primary objective of the present invention is to provide a hand tool having an antislip function.

Another objective of the present invention is to provide a hand tool, wherein the woven wool layer of the antislip member has a high friction, so that when the antislip member is mounted on the handle portion of the shank, the handle portion of the shank has a greater antislip feature, thereby facilitating a user holding the handle portion of the shank.

A further objective of the present invention is to provide a hand tool, wherein the woven wool layer of the antislip member has an outstanding appearance, thereby enhancing the aesthetic quality of the hand tool.

In accordance with one embodiment of the present invention, there is provided a hand tool, comprising a shank having a first end provided with a drive portion and a second end provided with a handle portion, and an antislip structure mounted on the handle portion of the shank. The antislip structure includes an antislip member mounted around the handle portion of the shank. The antislip member of the antislip structure includes a bonding glue bonded onto an outer surface of the handle portion of the shank and a woven wool layer mounted on a surface of the bonding glue.

Further benefits and advantages of the present invention will become apparent after a careful reading of the detailed description with appropriate reference to the accompanying drawings.

### BRIEF DESCRIPTION OF THE DRAWINGS

FIG. 1 is a perspective view of a hand tool in accordance with the preferred embodiment of the present invention;

FIG. 2 is a partially front cross-sectional view of the hand tool as shown in FIG. 1;

FIG. 3 is a front cross-sectional view of the hand tool as shown in FIG. 1;

FIG. 4 is a perspective view of a hand tool in accordance with another preferred embodiment of the present invention;

FIG. 5 is a perspective view of a hand tool in accordance with another preferred embodiment of the present invention;

FIG. 6 is a perspective view of a hand tool in accordance with another preferred embodiment of the present invention;

### DETAILED DESCRIPTION OF THE INVENTION

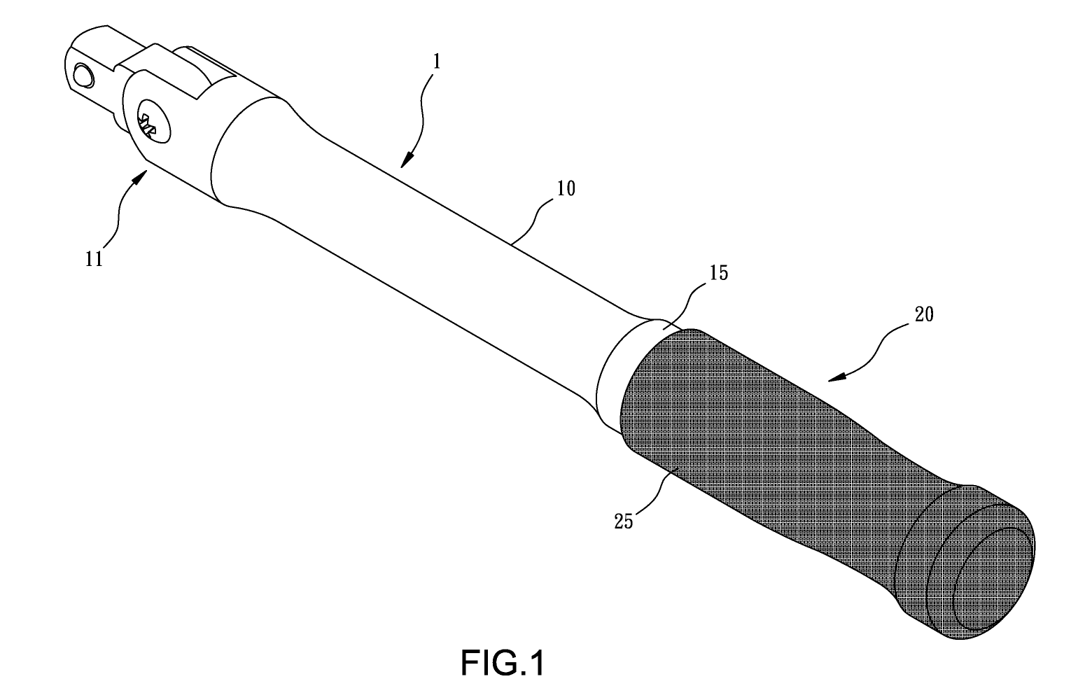

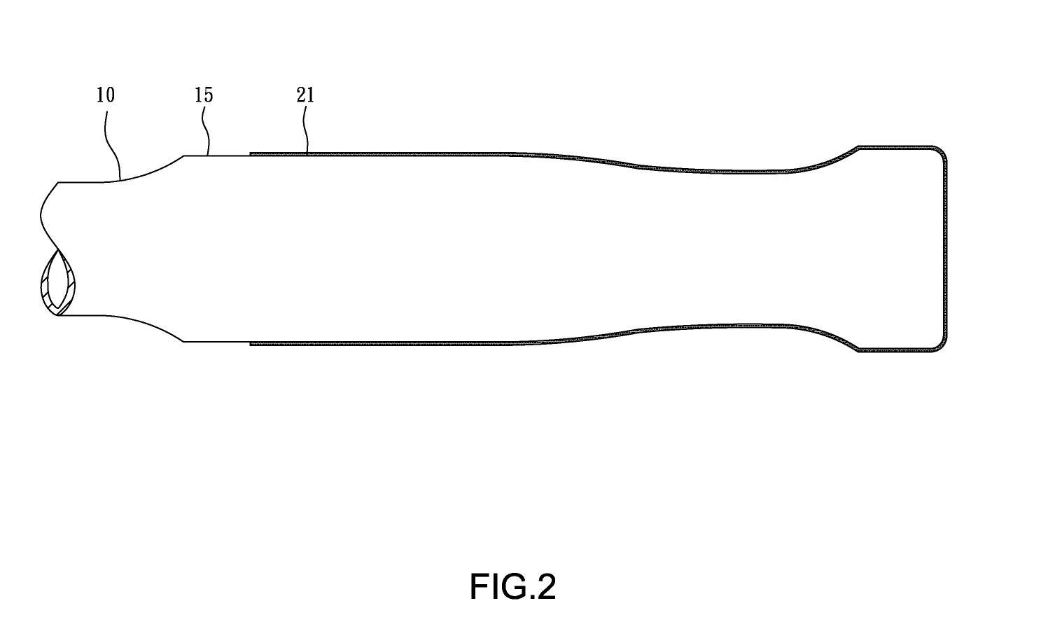

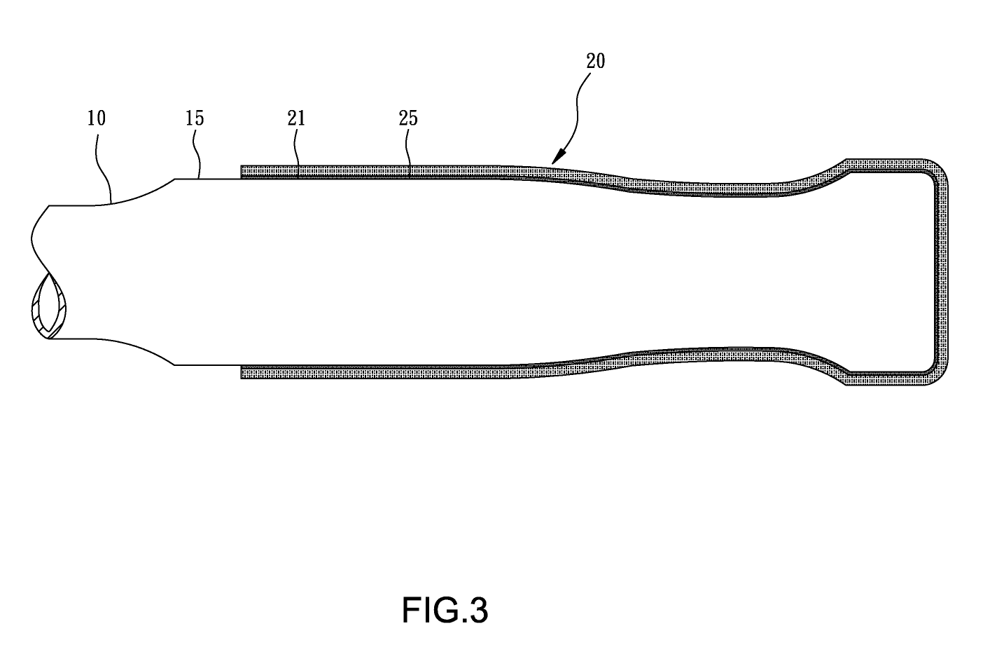

Referring to the drawings and initially to FIGS. 1-3, a hand tool 1 in accordance with the preferred embodiment of the present invention comprises a shank 10 having a first end provided with a drive portion 11 and a second end provided with a handle portion 15, and an antislip structure mounted on the handle portion 15 of the shank 10.

The shank 10 is made of metallic or wooden material.

The antislip structure includes an antislip member 20 mounted around the handle portion 15 of the shank 10. The antislip member 20 of the antislip structure includes a bonding glue 21 bonded onto an outer surface of the handle portion 15 of the shank 10, and a woven wool layer 25 mounted on a surface of the bonding glue 21. The antislip member 20 of the antislip structure encompasses the outer surface of the handle portion 15 of the shank 10 completely. The bonding glue 21 of the antislip member 20 is located between the woven wool layer 25 of the antislip member 20 and the outer surface of the handle portion 15 of the shank 10. The woven wool layer 25 of the antislip member 20 is mounted on the surface of the bonding glue 21 by an implanting technology, such as a static electricity implanting technology. The woven wool layer 25 of the antislip member 20 includes multiple high friction woven wools. The woven wool layer 25 of the antislip member 20 has a length ranged between 0.5 mm and 3 mm (millimeter) and has a diameter ranged between 0.01 mm and 0.3 mm.

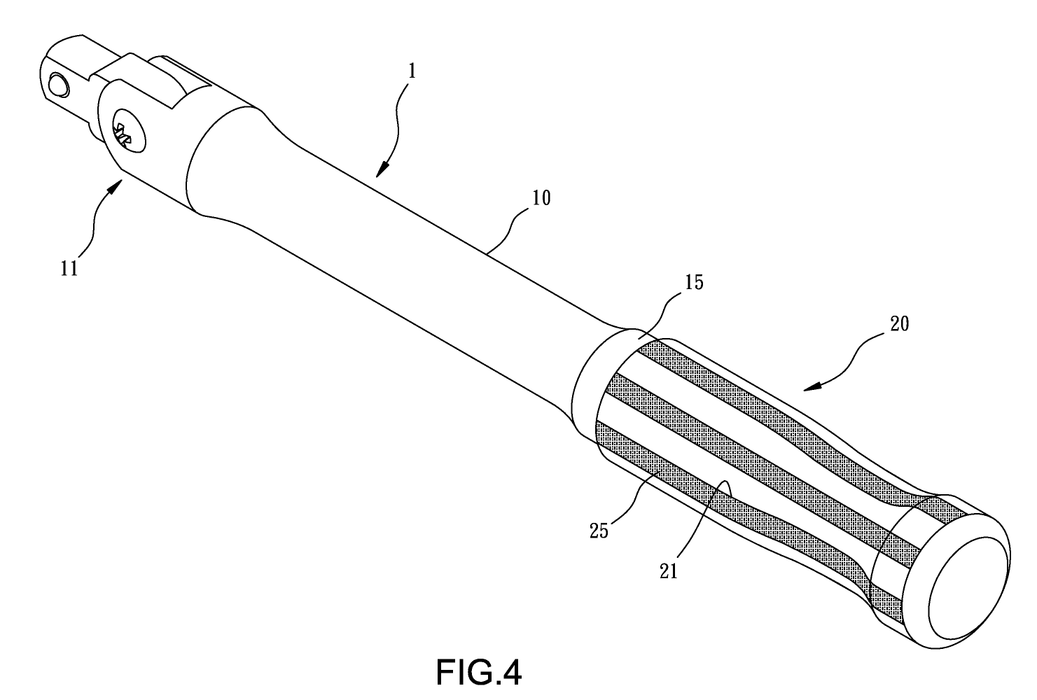

As shown in FIG. 4, the antislip structure includes a plurality of antislip members 20 mounted around the handle portion 15 of the shank 10. Each of the antislip members 20 of the antislip structure includes a bonding glue 21 bonded onto an outer surface of the handle portion 15 of the shank 10, and a woven wool layer 25 mounted on a surface of the bonding glue 21. Each of the antislip members 20 of the antislip structure is an elongate strip and extends in a longitudinal direction of the handle portion 15 of the shank 10. The antislip members 20 of the antislip structure are arranged on the outer surface of the handle portion 15 of the shank 10 in an annular manner and are equally spaced from each other.

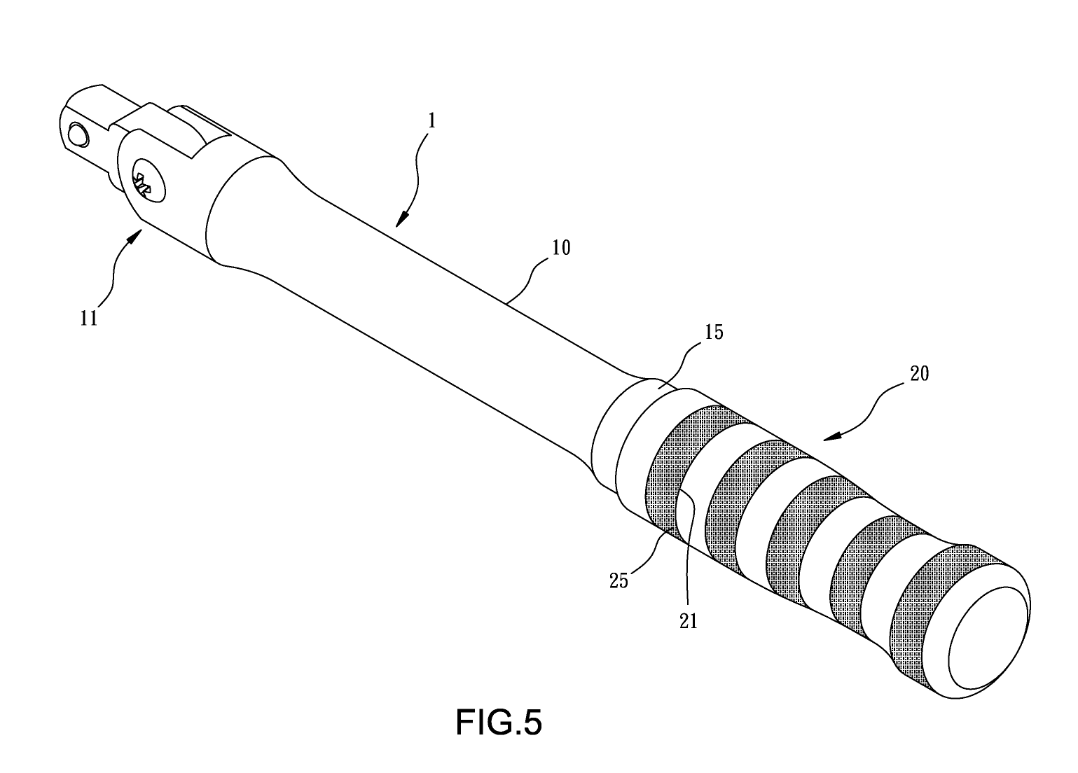

As shown in FIG. 5, the antislip structure includes a plurality of antislip members 20 mounted around the handle portion 15 of the shank 10. Each of the antislip members 20 of the antislip structure includes a bonding glue 21 bonded onto an outer surface of the handle portion 15 of the shank 10, and a woven wool layer 25 mounted on a surface of the bonding glue 21. Each of the antislip members 20 of the antislip structure is an annular strip and extends in a transverse direction of the handle portion 15 of the shank 10. The antislip members 20 of the antislip structure are arranged on the outer surface of the handle portion 15 of the shank 10 in a linear manner and are equally spaced from each other.

As shown in FIGS. 1-5, the hand tool 1 is a socket wrench.

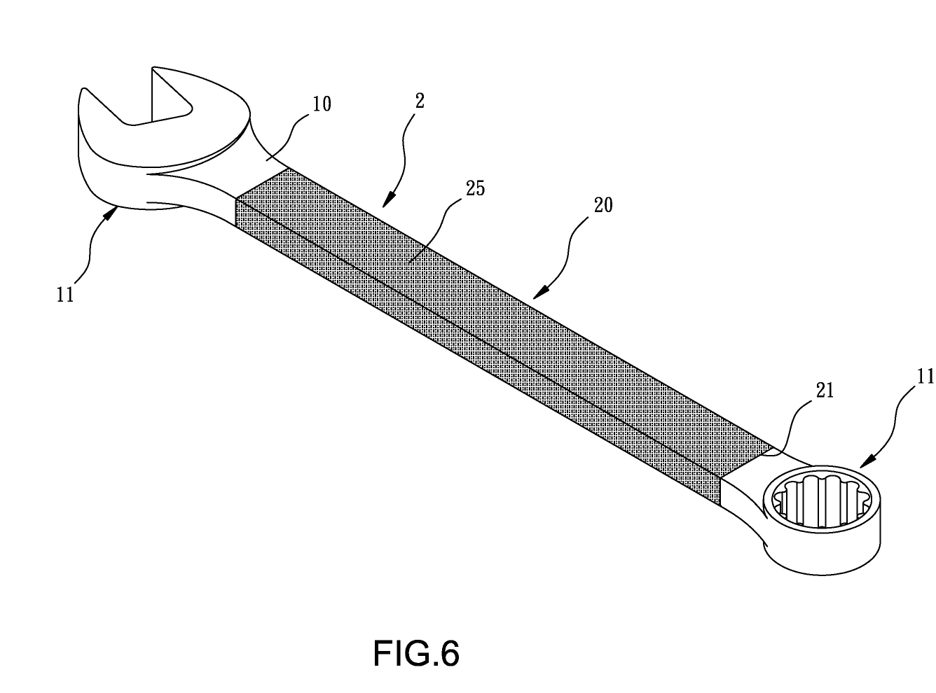

As shown in FIG. 6, the hand tool 2 is a combination wrench.

Accordingly, the woven wool layer 25 of the antislip member 20 has a high friction, so that when the antislip member 20 is mounted on the handle portion 15 of the shank 10, the handle portion 15 of the shank 10 has a greater antislip feature, thereby facilitating a user holding the handle portion 15 of the shank 10. In addition, the woven wool layer 25 of the antislip member 20 has an outstanding appearance, thereby enhancing the aesthetic quality of the hand tool.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

What is claimed is:

1. A hand tool, comprising:
a shank having a first end provided with a drive portion and a second end provided with a handle portion;
an antislip structure mounted on the handle portion of the shank;
the antislip structure includes an antislip member mounted around the handle portion of the shank;
the antislip member of the antislip structure includes:
a bonding glue bonded onto an outer surface of the handle portion of the shank;
a woven wool layer mounted on a surface of the bonding glue.

2. The hand tool in accordance with claim 1, wherein the antislip member of the antislip structure encompasses the outer surface of the handle portion of the shank completely.

3. The hand tool in accordance with claim 1, wherein the bonding glue of the antislip member is located between the woven wool layer of the antislip member and the outer surface of the handle portion of the shank.

4. The hand tool in accordance with claim 1, wherein the woven wool layer of the antislip member is mounted on the surface of the bonding glue by an implanting technology.

5. The hand tool in accordance with claim 4, wherein the woven wool layer of the antislip member is mounted on the surface of the bonding glue by a static electricity implanting technology.

6. The hand tool in accordance with claim 1, wherein the woven wool layer of the antislip member includes multiple high friction woven wools.

7. The hand tool in accordance with claim 1, wherein the woven wool layer of the antislip member has a length ranged between 0.5 mm and 3 mm (millimeter) and has a diameter ranged between 0.01 mm and 0.3 mm.

8. A hand tool, comprising:
a shank having a first end provided with a drive portion and a second end provided with a handle portion;
an antislip structure mounted on the handle portion of the shank;
the antislip structure includes a plurality of antislip members mounted around the handle portion of the shank;
each of the antislip members of the antislip structure includes:
a bonding glue bonded onto an outer surface of the handle portion of the shank;
a woven wool layer mounted on a surface of the bonding glue.

9. The hand tool in accordance with claim 8, wherein the bonding glue of each of the antislip members is located between the woven wool layer of the antislip member and the outer surface of the handle portion of the shank.

10. The hand tool in accordance with claim 8, wherein the woven wool layer of each of the antislip members is mounted on the surface of the bonding glue by an implanting technology.

11. The hand tool in accordance with claim 10, wherein the woven wool layer of each of the antislip members is mounted on the surface of the bonding glue by a static electricity implanting technology.

12. The hand tool in accordance with claim 8, wherein the woven wool layer of each of the antislip members includes multiple high friction woven wools.

13. The hand tool in accordance with claim 8, wherein the woven wool layer of each of the antislip members has a length ranged between 0.5 mm and 3 mm (millimeter) and has a diameter ranged between 0.01 mm and 0.3 mm.

14. The hand tool in accordance with claim 8, wherein each of the antislip members of the antislip structure is an elongate strip and extends in a longitudinal direction of the handle portion of the shank.

15. The hand tool in accordance with claim 14, wherein the antislip members of the antislip structure are arranged on the outer surface of the handle portion of the shank in an annular manner.

16. The hand tool in accordance with claim 15, wherein the antislip members of the antislip structure are equally spaced from each other.

17. The hand tool in accordance with claim 8, wherein each of the antislip members of the antislip structure is an annular strip and extends in a transverse direction of the handle portion of the shank.

18. The hand tool in accordance with claim 17, wherein the antislip members of the antislip structure are arranged on the outer surface of the handle portion of the shank in a linear manner and are equally spaced from each other.

19. The hand tool in accordance with claim 18, wherein the antislip members of the antislip structure are arranged on the outer surface of the handle portion of the shank in a linear manner and are equally spaced from each other.
